(19) United States
(12) Patent Application Publication
(10) Pub. No.: US 2015/0030388 A1
(43) Pub. Date: Jan. 29, 2015

(54) BUNDLING TOOL

(71) Applicant: Protec Engineering, Inc., Kitakanbara-gun, Niigata (JP)

(72) Inventors: Toshimitsu Nomura, Niigata-shi (JP); Tomohiro Fujii, Kanazawa-shi (JP); Masahito Shimizu, Nishikanbara-gun (JP)

(73) Assignee: Protec Engineering, Inc., Kitakanbara-gun, Niigata (JP)

(21) Appl. No.: 14/235,967

(22) PCT Filed: Feb. 14, 2013
(86) PCT No.: PCT/JP2013/053560

§ 371 Date: Jan. 29, 2014

(51) Int. Cl. F16B 7/04; E04C 5/18

(52) U.S. Cl. CPC F16B 7/044; E04C 5/18
USPC 403/400

(57) ABSTRACT

A bundling tool includes first and second bundling members in plate like shapes. The first and second bundling members respectively include central parts that cover wires, first locking parts that are bendable and extend from first sides of the central parts, and second locking parts that are bendable and extend from second sides of the central parts. When the first and second bundling members clamp the wires therebetween and are to be crimped, the first and second locking parts of the first bundling member are each folded down to abut on an outer surface of the second bundling member at an end part of the locking part, and the first and second locking parts of the second bundling member are each folded down to abut on an outer surface of the first bundling member at an end part of the locking part, thereby crimping the wires.

### TECHNICAL FIELD

The present invention relates to a bundling tool, and more particularly, a bundling tool for bundling an intersection part of a plurality of wires.

### BACKGROUND ART

For example, Japanese Unexamined Patent Application, Publication No. 1995-42367 discloses this kind of a bundling tool. Japanese Unexamined Patent Application, Publication No. 1995-42367 discloses an approximately cross shaped bundling tool having four tongue pieces. The bundling tool is applied to, for example, an intersection part of two wires disposed in a crisscross pattern, and the tongue pieces are folded down so as to hold the intersection part, thereby bundling the wires.

### THE DISCLOSURE OF THE INVENTION

### Problems to be Solved by the Invention

However, since the bundling tool described above is configured such that the bundling tool is applied to the wires from one side, and that the tongue pieces are crimped on the other side, it has been difficult to bundle the wires with sufficient tightness.

A drawback is encountered in that it is impossible to maintain the wires tightly bundled by means of the bundling tool when used for a long period of time.

The present invention has been made in view of the above described circumstances, and it is an object of the present invention to provide a bundling tool that can maintain wires tightly bundled even for a long term usage.

### Means for Solving the Problems

In accordance with a first aspect of the present invention, there is provided a bundling tool for bundling a plurality of wires at an intersection part thereof. The bundling tool includes: a first bundling member in a plate like shape; and a second bundling member in a plate like shape adapted to face toward the first bundling member and clamp the plurality of wires in collaboration with the first bundling member. The first bundling member and the second bundling member each include a central part for covering the wires, a first locking part being bendable and extending from a first side of the central part, and a second locking part being bendable and extending from a second side of the central part, the second side being opposite to the first side. When the first bundling member and the second bundling member clamp the plurality of wires therebetween and are to be crimped, the first locking part and the second locking part of the first bundling member are each folded down so as to abut on an outer surface of the second bundling member at an end part of the locking part, and the first locking part and the second locking part of the second bundling member are each folded down so as to abut on an outer surface of the first bundling member at an end part of the locking part, thereby crimping the plurality of wires.

In accordance with a second aspect of the present invention, in addition to the first aspect of the present invention, the first bundling member and the second bundling member are each provided with a first embossed part and a second embossed part at the central part thereof. The first embossed part and the second embossed part are formed with respective concave parts on the outer surface of the central part facing toward third and fourth sides of the central part, the third side being a side between the first side and the second side, the fourth side being a side opposite to the third side, and formed with respective convex parts on an inner surface of the central part reflecting the concave form on the outer surface. When the first locking part and the second locking part of the first bundling member are folded down, the end parts thereof respectively abut on the concave parts on the outside of the first embossed part and the second embossed part of the second bundling member, and when the first locking part and the second locking part of the second bundling member are folded down, the end parts thereof respectively abut on the concave parts on the outside of the first embossed part and the second embossed part of the first bundling member.

In accordance with a third aspect of the present invention, in addition to the second aspect of the present invention, the central parts of the first bundling member and the second bundling member accommodate the wires between the inner surfaces thereof at locations other than the convex parts on the inside of the first embossed part and the second embossed part.

In accordance with a fourth aspect of the present invention, in addition to the first aspect of the present invention, the first locking part and the second locking part of the first bundling member and the second bundling member each include the end part narrowing toward a tip end thereof.

In accordance with a fifth aspect of the present invention, in addition to the first aspect of the present invention, the first locking part and the second locking part of the first bundling member and the second bundling member have lengths within a range of between 180% and 220% of the diameter of one of the wires before being crimped.

In accordance with a sixth aspect of the present invention, in addition to the first aspect of the present invention, when the first bundling member and the second bundling member crimp the plurality of wires, the first bundling member and the second bundling member are fixed in a distance within a range of between 50% and 150% of the diameter of one of the wires before being crimped.

In accordance with a seventh aspect of the present invention, in addition to the first or sixth aspect of the present invention, when the first bundling member and the second bundling member crimp the plurality of wires, the first bundling member and the second bundling member are fixed in a distance approximately equal to the diameter of one of the wires before being crimped.

In accordance with an eighth aspect of the present invention, in addition to the first aspect of the present invention, the first locking part and the second locking part of the first bundling member are welded at respective abutment locations with the second locking part and first locking part of the second bundling member.

In accordance with a ninth aspect of the present invention, in addition to the first aspect of the present invention, the first locking part and the second locking part of the first bundling member and the second bundling member have widths narrower than the diameter of one of the wires before being crimped.

### Effect of the Invention

According to the bundling tool described above, it becomes possible to tightly bundle the wires even for a long term usage.

### BRIEF DESCRIPTION OF THE DRAWINGS

FIG. 1 is a perspective view of a first bundling member, a first wire, a second wire, and a second bundling member, which are to be placed one on top of another, of a bundling tool according to the present invention;

FIG. 2 is a perspective view of the first bundling member, the first wire, the second wire, and the second bundling member, which have been placed one on top of another but not yet been bundled, of the bundling tool according to the present invention;

FIG. 3 is a perspective view of the first bundling member, the first wire, the second wire, and the second bundling member, which have been bundled, of the bundling tool according to the present invention;

FIG. 4 is a view of an outer surface of a first member to be formed into the first bundling member of the bundling tool according to the present invention;

FIG. 5 is a view of an inner surface of the first member to be formed into the first bundling member of the bundling tool according to the present invention;

FIG. 6 is a side view of the first bundling member of the bundling tool according to the present invention showing a state in which a first end part and a second end part are not yet folded down;

FIG. 7 is a view of an outer surface of the first bundling member of the bundling tool according to the present invention;

FIG. 8 is a view of an inner surface of the first bundling member of the bundling tool according to the present invention;

FIG. 9 is a view of an outer surface of a second member to be formed into the second bundling member of the bundling tool according to the present invention;

FIG. 10 is a view of an inner surface of the second member to be formed into the second bundling member of the bundling tool according to the present invention;

FIG. 11 is a side view of the first bundling member of the bundling tool according to the present invention showing a state in which the first end part and the second end part have been folded down; and

FIG. 12 is a view showing another example of the first bundling member drawn corresponding to FIG. 4.

### BEST MODE FOR CARRYING OUT THE INVENTION

In the following, a detailed description will be given of best modes for carrying out the present invention (hereinafter, referred to as “embodiments”) with reference to drawings. Throughout the following description of the embodiments, the same constituent elements are denoted by the same reference numerals.

### First Embodiment

FIG. 1 is a perspective view showing a bundling tool 1 according to the present invention along with a plurality of wires.

The bundling tool 1 according to the present invention is provided with a first member 10 and a second member 20 and adapted to bundle an intersection part of a first wire 100 and a second wire 200 made of iron or stainless steel, for example. As the first wire 100 and the second wire 200, for example, wires constituting a rockfall protection net, reinforcing rods of reinforced concrete structure, or the like are employed.

Hereinafter, directions are defined as follows: When the bundling is performed, a direction in which a second locking part 12, a first central part 13, and a first locking part 11 of a first bundling member 10a are formed in this order is defined to be an x direction, and a direction in which a second locking part 22, a second central part 23, and a first locking part 21 of a second bundling member 20a are formed in this order is defined to be a y direction, which is perpendicular to the x direction. A direction in which the first bundling member 10a, the first wire 100, the second wire 200, and the second bundling member 20a are placed one on top of another in this order is defined to be a z direction, which is perpendicular to the x and y directions.

The first bundling member 10a is configured in a shape of a square bracket by bending both ends (the first locking part 11 and the second locking part 12) of the first member 10. The second bundling member 20a is configured in the shape of the square bracket by bending both ends (the first locking part 21 and the second locking part 22) of the second member 20. The first bundling member and the second bundling member 10a and 20a clamp the first wire 100 and the second wire 200 in a state of intersection part with each other, and then, are crimped, thereby bundling the first wire 100 and the second wire 200 (see FIGS. 1 to 3).

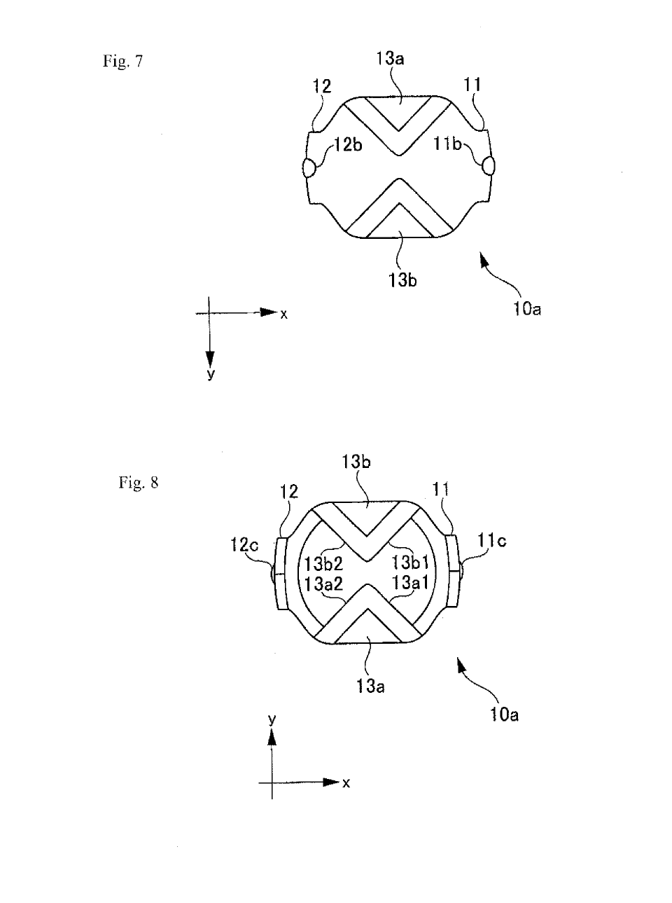

The first member 10 and the second member 20 are the same in structure. Firstly, a description will be given of a configuration of the first member 10 with reference to FIGS. 4 to 9.

The first member 10 is a plate like member made of stainless steel and includes the first locking part 11, the second locking part 12, and the first central part 13. The first central part 13 is located between the first locking part 11 and the second locking part 12.

The first central part 13 is wider in the y direction than the first locking part 11 and the second locking part 12. the first locking part 11 and the second locking part 12 are provided so as to be protruded in the x direction from a midpoint in the y direction of the first central part 13.

the first locking part 11 and the second locking part 12 are each configured to have a length in a range of between 180% and 220% in relation to a diameter of either one of the first wire 100 and the second wire 200.

The first locking part 11 is formed at an end (a part distant from the first central part 13) thereof with a first end part 11a approximately in a shape of an isosceles triangle, whose width in the y direction narrows toward a tip end thereof. The second locking part 12 is formed at an end (a part distant from the first central part 13) thereof with a second end part 12a approximately in the shape of the isosceles triangle, whose width in the y direction narrows toward a tip end thereof.

A length in the x direction of the first locking part 11 excluding the first end part 11a (a length in the x direction of a square shaped part of the first locking part 11) and a length in the x direction of the second locking part 12 excluding the second end part 12a (a length in the x direction of a square shaped part of the second locking part 12) are each longer than the diameters of the first wire 100 and the second wire 200 and shorter than a sum of the diameters of the first wire 100 and the second wire 200.

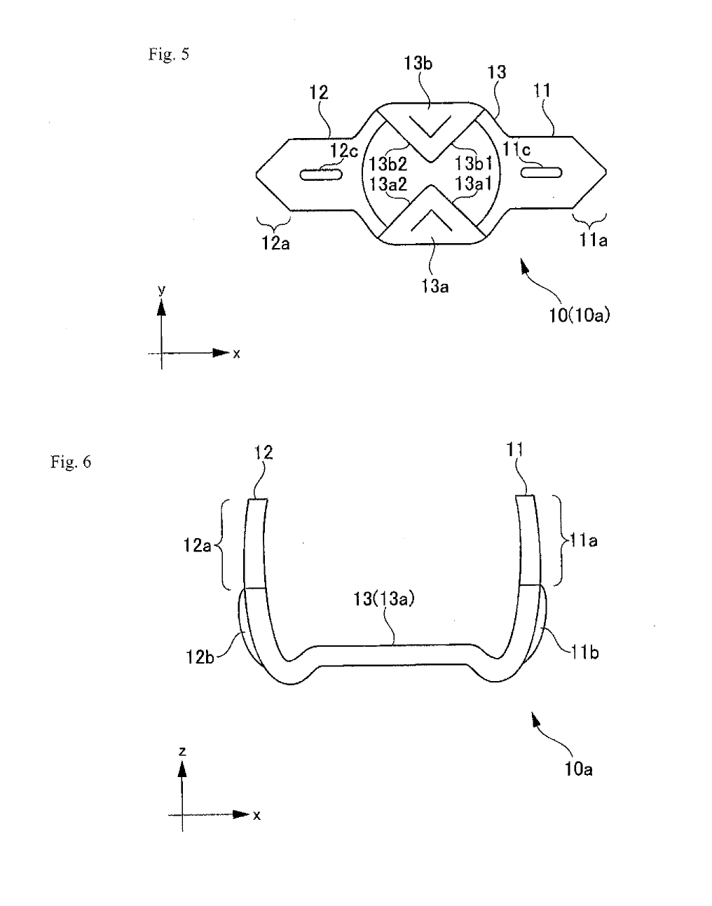

For a purpose of reinforcement, the first locking part 11 and the second locking part 12 are respectively formed with a first convex part 11b and a second convex part 12b extending in the x direction on outer surfaces (surfaces facing toward outside when the locking parts are bent) thereof (see FIG. 4), and, for a purpose of reinforcement, the first locking part 11 and the second locking part 12 are respectively formed with a first concave part 11c and a second concave part 12c extending in the x direction on inner surfaces (surfaces facing toward inside when the locking parts are bent) thereof (see FIG. 5).

The first central part 13 is formed with a first embossed part 13a and a second embossed part 13b on respective sides in the y direction. The first embossed part 13a and the second embossed part 13b are each concave on an outer surface, convex on an inner surface, and approximately in the shape of the isosceles triangle, whose width in the x direction widens toward an edge in the y direction.

The approximate isosceles triangles of the concave parts on the outer surfaces of the first embossed part 13a and the second embossed part 13b are respectively configured to be the same or slightly larger in dimension than the approximate isosceles triangles of a second end part 22a and a first end part 21a, which will be described later, of the second member 20.

The approximate isosceles triangles of the convex parts on the inner surfaces of the first embossed part 13a and the second embossed part 13b are configured in dimension so that a part of the first wire 100 is accommodated in a region which is not convex between a line including a side 13a1 on a side of the first locking part 11 of the first embossed part 13a and a line including a side 13b2 on a side of the second locking part 12 of the second embossed part 13b, and that apart of the second wire 200 is accommodated in a region which is not convex between a line including a side 13a2 on a side of the second locking part 12 of the first embossed part 13a and a line including a side 13b1 on a side of the first locking part 11 of the second embossed part 13b.

the first locking part 11 and the second locking part 12 are bent at respective boundaries with the first central part 13 so that the first concave part 11c and the second concave part 12c face toward each other, the first locking part 11 and the second locking part 12 are in an approximately parallel relationship with each other, and the first member 10 is in the shape of the square bracket viewing from the y direction, thereby forming the first bundling member 10a (see FIGS. 6 to 8).

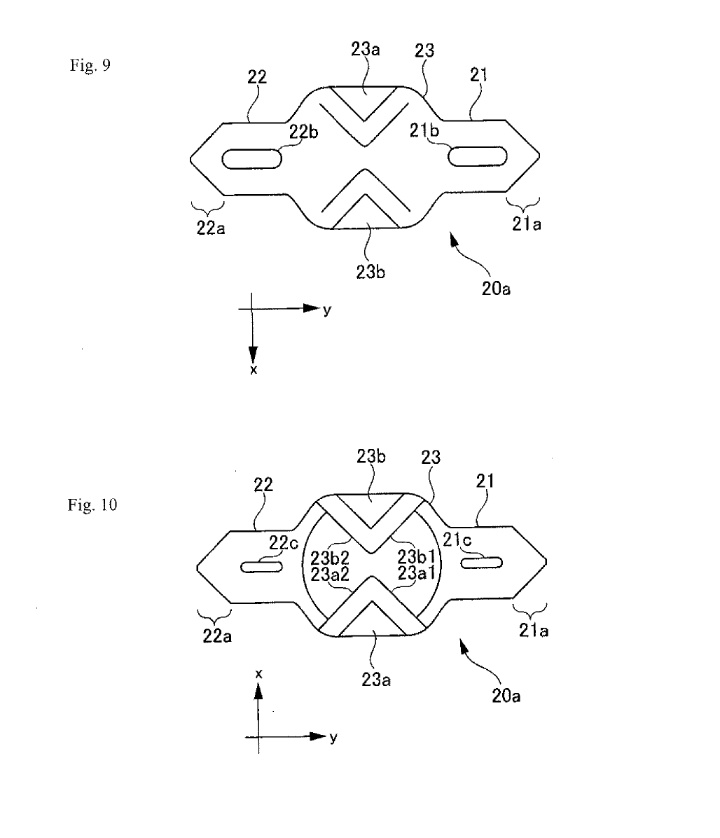

The second member 20 is a plate like member made of stainless steel and includes the first locking part 21, the second locking part 22, and the second central part 23. The second central part 23 is located between the first locking part 21 and the second locking part 22 (see FIGS. 9 and 10).

The second central part 23 is wider in the x direction than the first locking part 21 and the second locking part 22. The first locking part 21 and the second locking part 22 are provided so as to be protruded in the y direction from a midpoint in the x direction of the second central part 23.

The first locking part 21 and the second locking part 22 are each configured to have a length in a range of between 180% and 220% in relation to the diameter of either one of the first wire 100 and the second wire 200.

The first locking part 21 is formed at an end (a part distant from the second central part 23) thereof with a first end part 21a approximately in the shape of the isosceles triangle, whose width in the x direction narrows toward a tip end thereof. The second locking part 22 is formed at an end (a part distant from the second central part 23) thereof with a second end part 22a approximately in the shape of the isosceles triangle, whose width in the x direction narrows toward a tip end thereof.

A length in the y direction of the first locking part 21 excluding the first end part 21a (a length in the y direction of a square shaped part of the first locking part 21) and a length in the y direction of the second locking part 22 excluding the second end part 22a (a length in the y direction of a square shaped part of the second locking part 22) are each longer than the diameters of the first wire 100 and the second wire 200 and shorter than the sum of the diameters of the first wire 100 and the second wire 200.

For a purpose of reinforcement, the first locking part 21 and the second locking part 22 are respectively formed with a first convex part 21b and a second convex part 22b extending in the y direction on outer surfaces (surfaces facing toward outside when the locking parts are bent) thereof (see FIG. 9), and, for a purpose of reinforcement, the first locking part 21 and the second locking part 22 are respectively formed with a first concave part 21c and a second concave part 22c extending in the y direction on inner surfaces (surfaces facing toward inside when the locking parts are bent) thereof (see FIG. 10).

The second central part 23 is formed with a first embossed part 23a and a second embossed part 23b on respective sides in the x direction. The first embossed part 23a and the second embossed part 23b are each concave on an outer surface, convex on an inner surface, and approximately in the shape of the isosceles triangle, whose width in the y direction widens toward an edge in the x direction.

The approximate isosceles triangles of the concave parts on the outer surfaces of the first embossed part 23a and the second embossed part 23b are respectively configured to be the same or slightly larger in dimension than the approximate isosceles triangles of the second end part 12a and the first end part 11a of the first member 10.

The approximate isosceles triangles of the convex parts on the inner surfaces of the first embossed part 23a and the second embossed part 23b are configured in dimension so that a part of the first wire 100 is accommodated in a region which is not convex between a line including a side 23a1 on a side of the first locking part 21 of the first embossed part 23a and a line including a side 23b2 on a side of the second locking part 22 of the second embossed part 23b, and that a part of the second wire 200 is accommodated in a region which is not convex between a line including a side 23a2 on a side of the second locking part 22 of the first embossed part 23a and a line including a side 23b1 on a side of the first locking part 21 of the second embossed part 23b.

The first locking part 21 and the second locking part 22 are bent at respective boundaries with the second central part 23 so that the first concave part 21c and the second concave part 22c face toward each other, the first locking part 21 and the second locking part 22 are in an approximately parallel relationship with each other, and the second member 20 is in the shape of the square bracket viewing from the x direction, thereby forming the second bundling member 20a.

In the following, a description will be given of a procedure of bundling the intersection part of the first wire 100 and the second wire 200 by crimping the first bundling member and the second bundling member 10a and 20a, which have been formed in the shape of the square bracket, so that the first bundling member 10a, the first wire 100, the second wire 200, and the second bundling member 20a are put closely together.

On the first bundling member 10a, the first wire, the second wire, and the second bundling member 20a are placed (see FIG. 1).

The first wire 100 is disposed in a positional relationship such that, in the first bundling member 10a, a part of the first wire 100 is hold by the region which is not convex between the line including the side 13a1 on the side of the first locking part 11 of the first embossed part 13a and the line including the side 13b2 on the side of the second locking part 12 of the second embossed part 13b, and, in the second bundling member 20a, a part of the first wire 100 is hold by the region which is not convex between the line including the side 23a1 on the side of the first locking part 21 of the first embossed part 23a and the line including the side 23b2 on the side of the second locking part 22 of the second embossed part 23b.

Furthermore, the first wire 100 is disposed between the first locking part 11 of the first bundling member 10a and the second locking part 22 of the second bundling member 20a, and between the second locking part 12 of the first bundling member 10a and the first locking part 21 of the second bundling member 20a.

The second wire 200 is disposed in a positional relationship such that, in the first bundling member 10a, a part of the second wire 200 is hold by the region which is not convex between the line including the side 13a2 on the side of the second locking part 12 of the first embossed part 13a and the line including the side 13b1 on the side of the first locking part 11 of the second embossed part 13b, and, in the second bundling member 20a, a part of the second wire 200 is hold by the region which is not convex between the line including the side 23a2 on the side of the second locking part 22 of the first embossed part 23a and the line including the side 23b1 on the side of the first locking part 21 of the second embossed part 23b.

Furthermore, the second wire 200 is disposed between the first locking part 11 of the first bundling member 10a and the first locking part 21 of the second bundling member 20a, and between the second locking part 12 of the first bundling member 10a and the second locking part 22 of the second bundling member 20a. This means that, the intersection part of the first wire 100 and the second wire 200 is disposed at a location, which is between the first locking part 11 and the second locking part 12, between the first locking part 21 and the second locking part 22, and between the first central part 13 and the second central part 23.

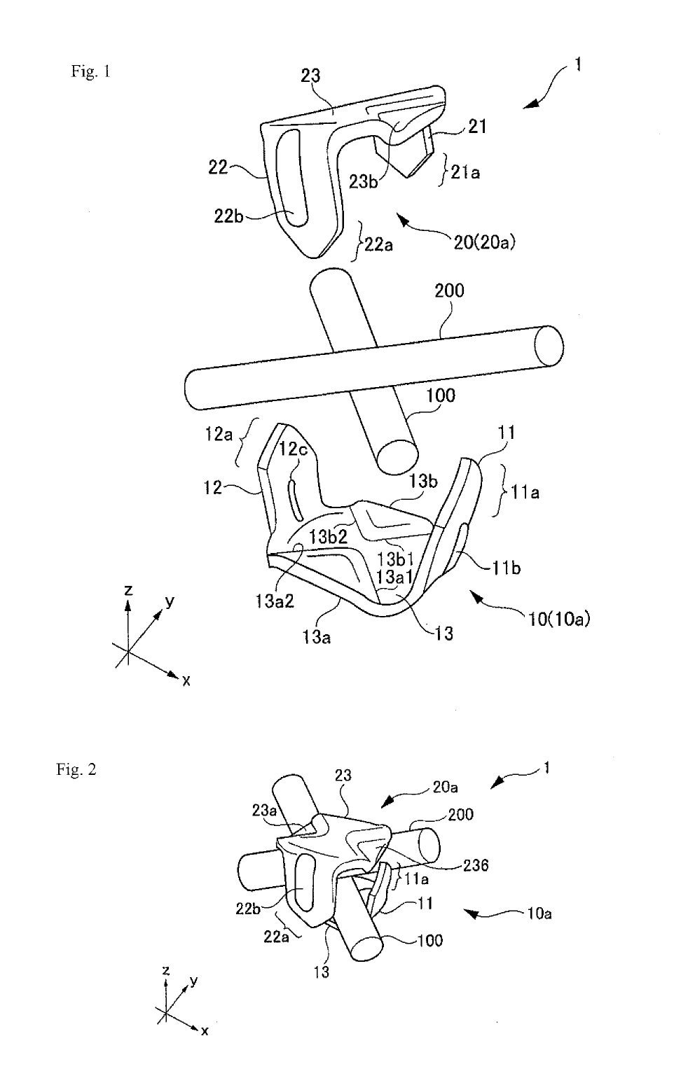

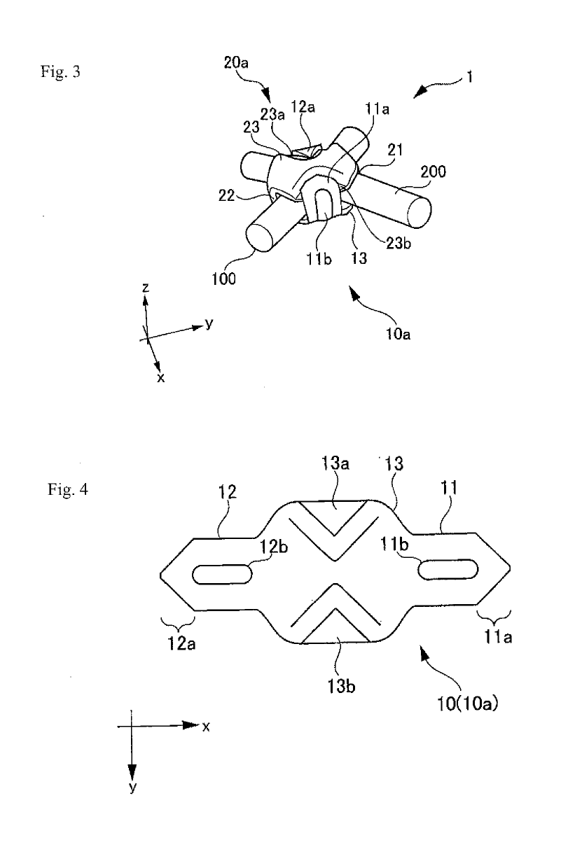

Thus, the first wire 100 and the second wire 200 intervene between the first bundling member and the second bundling member 10a and 20a in a state of intersection part (see FIG. 2). In a state of FIG. 2, the crimping is performed so that the first bundling member and the second bundling member 10a and 20a are pressed and fixed in a vertical direction (the z direction), and the first end part 11a, the second end part 12a, the first end part 21a, and the second end part 22a are folded down toward inside (see FIG. 3).

Here, it is preferred that the thickness of the first locking part 11 and the second locking part 12 of the first bundling member 10a be approximately equal to the depth of the concave parts of the first embossed part 23a and the second embossed part 23b of the second bundling member 20a, and that the thickness of the first locking part 21 and the second locking part 22 of the second bundling member 20a be approximately equal to the depth of the concave parts of the first embossed part 13a and the second embossed part 13b of the first bundling member 10a. As a result of this, it is possible to attain the bundling tool 1 that is less up and down on a surface thereof.

The first wire 100 and the second wire 200 are squashed at around the intersection part in the z direction by being pressed as described above. The first wire 100 and the second wire 200 are accommodated within a range of a height of the first bundling member 10a excluding the first end part 11a, which corresponds to a length of the first locking part 11 excluding the first end part 11a.

Here, it is preferred that, when the first bundling member and the second bundling member 10a and 20a crimp the first wire 100 and the second wire 200, a distance between the first bundling member and the second bundling member 10a and 20a reach a dimension within a range of between 50% to 150% of the diameter of either one of the first wire 100 and the second wire 200 that were not yet crimped. Furthermore, it is preferred that the distance reach a dimension approximately the same as the diameter of either one of the first wire 100 and the second wire 200 that were not yet crimped. This is because it is possible to reinforce the bundling of the first wire 100 and the second wire 200.

Here, in the first bundling member 10a, a part of the first wire 100 is pushed into the region which is not convex between the line including the side 13a1 on the side of the first locking part 11 of the first embossed part 13a and the line including the side 13b2 on the side of the second locking part 12 of the second embossed part 13b, and, in the second bundling member 20a, a part of the first wire 100 is pushed into the region which is not convex between the line including the side 23a1 on the side of the first locking part 21 of the first embossed part 23a and the line including the side 23b2 on the side of the second locking part 22 of the second embossed part 23b.

Also, in the first bundling member 10a, apart of the second wire 200 is pushed into the region which is not convex between the line including the side 13a2 on the side of the second locking part 12 of the first embossed part 13a and the line including the side 13b1 on the side of the first locking part 11 of the second embossed part 13b, and, in the second bundling member 20a, apart of the second wire 200 is pushed into the region which is not convex between the line including the side 23a2 on the side of the second locking part 22 of the first embossed part 23a and the line including the side 23b1 on the side of the first locking part 21 of the second embossed part 23b.

Hereinafter, a more particular description will be given of the folding of the first end part 11a and the like. The first end part 11a is folded down so as to face toward the concave part (outside) of the second embossed part 23b of the second bundling member 20a, the second endpart 12a is folded down so as to face toward the concave part (outside) of the first embossed part 23a of the second bundling member 20a, the first end part 21a is folded down so as to face toward the concave part (outside) of the second embossed part 13b of the first bundling member 10a, and the second end part 22a is folded down so as to face toward the concave part (outside) of the first embossed part 13a of the first bundling member 10a.

This means that the first end part 11a, the second end part 12a, the first end part 21a, and the second end part 22a are each brought approximately parallel to the first central part 13 and the second central part 23. FIG. 11 shows the first end part 11a and the like being folded down for bundling in a state without the second bundling member 20a, the first wire 100, and the second wire 200.

The pressing and folding described above may be performed separately, and may be performed at once as a process of crimping by means of a crimping tool.

It becomes possible to bundle the first wire 100 and the second wire 200 in a state of intersection between the first bundling member and the second bundling member 10a and 20a by crimping.

Since the first wire 100 and the second wire 200 are squashed and deformed at around the intersection part at the time of pressing, even if a tension is exerted in an axial direction after bundling, it is not likely that the wires slide off in comparison with a case in which the wires are bundled without being squashed.

Furthermore, since the first end part 11a and the like are each folded down and engaged with the concave part on the outside of the bundling member so as to hold the part of the opposing bundling member, it is not likely that the bundling comes off even if a force is exerted in the z direction to separate the first bundling member and the second bundling member 10a and 20a after being bundled.

Especially, the first end part 11a and the second end part 12a of the first bundling member 10a partially hold the second bundling member 20a, and the first end part 21a and the second end part 22a of the second bundling member 20a partially hold the first bundling member 10a. This means that the intersection part of the first wire 100 and the second wire 200 is held from one side by the first bundling member 10a and held from the other side by the second bundling member 20a. Accordingly, in comparison with a case in which the intersection part is held from only one side, it becomes possible to maintain the bundling for a long period of time. Furthermore, even if the hold comes off on either side, it is possible to maintain the bundling.

Since the first member 10 and the second member 20 can be configured by the plate like member of the same shape, there is an advantage in that the bundling members of the bundling tool 1 are easily prepared employing only one type of members. Accordingly, in comparison with a case in which a complex shaped bundling tool is employed for bundling, it is possible to simplify both processes for manufacturing of the bundling members and for bundling.

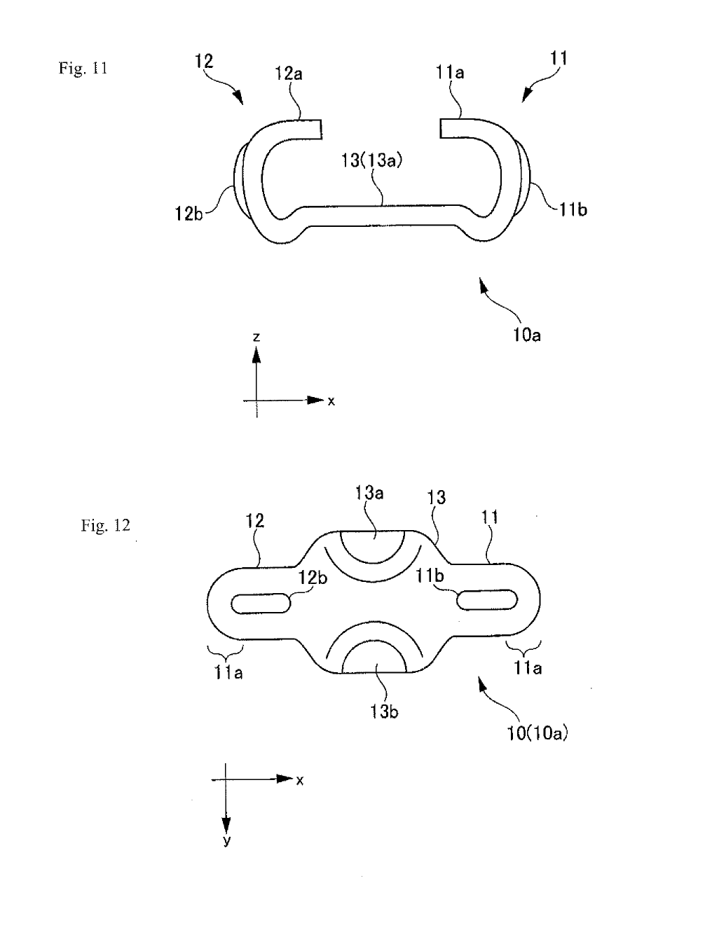

Although it has been described that the first end part 11a and the second end part 12a and the like are approximately in the shape of the isosceles triangle, other shapes that become narrower as becoming more distant from the center of the bundling member (such as a semicircle or a semi ellipse) may be employed. FIG. 12 is a view, drawn corresponding to FIG. 4, showing a case in which the first end part 11a and the second end part 12a are semicircles, for example. Accordingly, the first embossed part 13a and the second embossed part 13b are configured to be formed in semicircles as well. In this case also, the dimensions of the convex parts on the inside of the first embossed part 13a and the second embossed part 13b are configured so that the region that is not convex on the inside of the first central part 13 can accommodate the parts of the first wire 100 and the second wire 200. Similarly, the dimensions of the convex parts on the inside of the first embossed part 23a and the second embossed part 23b are configured so that the region that is not convex on the inside of the second central part 23 can accommodate the parts of the first wire 100 and the second wire 200.

Since the first end part 11a is folded down so as to face toward the concave part (outside) of the second embossed part 23b of the second bundling member 20a, and the second end part 12a is folded down so as to face toward the concave part (outside) of the first embossed part 23a of the second bundling member 20a, it becomes possible, after bundling, to reduce protrusion of the folded first end part 11a and second end part 12a from the outside of the second central part 23 in comparison with a case in which the folding is performed without providing the concave parts. Similarly, the first end part 21a is folded down so as to face toward the concave part (outside) of the second embossed part 13b of the first bundling member 10a, and the second end part 22a is folded down so as to face toward the concave part (outside) of the first embossed part 13a of the first bundling member 10a, it becomes possible, after bundling, to reduce protrusion of the folded first end part 21a and the second end part 22a from the outside of the first central part 13 in comparison with a case in which the folding is performed without providing the concave parts. This reduction in protrusion enables reduction in possibility of receiving a force pushing back the folding due to contact with other members.

Furthermore, the region that is not convex on the inside of the first central part 13 and the region that is not convex on the inside of the second central part 23 accommodate the parts of the first wire 100 and the second wire 200, and the convex part on the inside of the first central part 13 and the convex part on the inside of the second central part 23 lock the movement of the first wire 100 and the second wire 200 in the x direction and the y direction, thereby enabling to maintain the bundling state.

As is obvious from the above description, according to the bundling tool 1 of the first embodiment, it becomes possible to tightly bundle wires even for a long term usage.

### Second Embodiment

In the first embodiment described above, the first wire and the second wire are bundled with relatively strong pressure by the first bundling member and the second bundling member 10a and 20a. However, it maybe configured such that the length in the x direction of the first locking part 11 excluding the first end part 11a (the length in the x direction of the square shaped part of the first locking part 11), the length in the x direction of the second locking part 12 excluding the second end part 12a (the length in the x direction of the square shaped part of the second locking part 12), the length in the y direction of the first locking part 21 excluding the first end part 21a (the length in the y direction of the square shaped part of the first locking part 21), and the length in the y direction of the second locking part 22 excluding the second end part 22a (the length in they direction of the square shaped part of the second locking part 22) are approximately equal to the sum of the diameters of the first wire 100 and the second wire 200, the first wire 100 and the second wire 200 are loosely pressed or the pressing process is omitted, approximately without squashing the part around the intersection part of the first wire 100 and the second wire 200, and the first bundling member 10a is crimped, thereby bundling the first wire 100 and the second wire 200.

### Third Embodiment

Furthermore, in the present invention, the form of the bundling members is not limited to the configuration described above as long as it is possible that the two bundling members (the first bundling member and the second bundling member 10a and 20a) are applied to the first wire 100 and the second wire 200 at the intersection part from both sides in the vertical direction, one of the bundling members is folded down at both end parts thereof so as to hold a part of the other bundling member, and the other bundling member is folded down at both end parts thereof so as to hold a part of the one bundling member. For example, both the first member 10 and the second member 20 may be square shaped.

### Fourth Embodiment

Furthermore, in the embodiment described above, a description has been given of a configuration such that the plate like first member 10 and second member 20 are bent so as to form the first bundling member and the second bundling member 10a and 20a. However, it is obvious that any method other than bending the plate like members may be employed to prepare the bundling members.

### Fifth Embodiment

In the embodiment described above, it has been described that nothing is done after crimping the first bundling member and the second bundling member 10a and 20a that have clamped the first wire 100 and the second wire 200. However, the present invention is not limited to this, and it is obvious that the first locking part 11 and the second locking part 12 of the first bundling member 10a may be welded at respective abutment locations with the second locking part 22 and first locking part and 21 of the second bundling member 20a. This is for the purpose of preventing from coming off the crimp of the first locking part 11 and the second locking part 12 of the first bundling member 10a and/or the crimp of the first locking part 21 and the second locking part 22 of the second bundling member 20a.

### Sixth Embodiment

Furthermore, in the present invention, it maybe configured such that the first locking part 11 and the second locking part 12 of the first bundling member 10a and the first locking part 21 and the second locking part 22 of the second bundling member 20a have narrower widths than the diameter of either one of the first wire 100 and the second wire 200 before being crimped.

As a result of this, it becomes possible to adjust the intersection angle of the first wire 100 and the second wire 200.

It should be noted that the present invention is not limited to the scope described in the embodiments described above. It will be evident to those skilled in the art that any modifications and improvements may be made to the embodiments described above. It should be noted that such modifications and improvements are included in the scope of the present invention.

### EXPLANATION OF REFERENCE NUMERALS

1 Bundling Tool
10 First Member
10a First Bundling Member
11 First Locking Part
12 Second Locking Part
11a First End Part
12a Second End Part
11b First Convex Part
12b Second Convex Part
11c First Concave Part
12c Second Concave Part
13 First Central Part
13a First Embossed Part
13b Second Embossed Part
13a1, 13a2 Sides Constituting Isosceles Triangle of First Embossed Part
13b1, 13b2 Sides Constituting Isosceles Triangle of Second Embossed Part
20 Second Member
20a Second Bundling Member
21 First Locking Part
22 Second Locking Part
21a First End Part
22a Second End Part
21b First Convex Part
22b Second Convex Part
21c First Concave Part
22c Second Concave Part
23 Second Central Part
23a First Embossed Part
23b Second Embossed Part
23a1, 23a2 Sides Constituting Isosceles Triangle of First Embossed Part
23b1, 23b2 Sides Constituting Isosceles Triangle of Second Embossed Part
100 First Wire
200 Second Wire

1. A bundling tool for bundling a plurality of wires at an intersection part thereof, comprising:
a first bundling member in a plate like shape; and
a second bundling member in a plate like shape adapted to face toward the first bundling member and clamp the plurality of wires in collaboration with the first bundling member,
wherein the first bundling member and the second bundling member each include a central part for covering the wires, a first locking part being bendable and extending from a first side of the central part, and a second locking part being bendable and extending from a second side of the central part, wherein the second side is arranged in opposite relation to the first side,
wherein when the first bundling member and the second bundling member clamp the plurality of wires therebetween and are to be crimped, the first locking part and the second locking part of the first bundling member are each folded down so as to abut on an outer surface of the second bundling member at an end part of the locking part, and the first locking part and the second locking part of the second bundling member are each folded down so as to abut on an outer surface of the first bundling member at an end part of the locking part, thereby crimping the plurality of wires, and
wherein when the first bundling member and the second bundling member crimp the plurality of wires, the first bundling member and the second bundling member are fixed in a distance within a range of between 50% and 150% of the diameter of one of the wires before being crimped.

2. The bundling tool according to claim 1,
wherein the first bundling member and the second bundling member are each provided with a first embossed part and a second embossed part at the central part thereof, the first embossed part and the second embossed part being formed with respective concave parts on the outer surface of the central part facing toward third and fourth sides of the central part, the third side being a side between the first side and the second side, the fourth side being a side opposite to the third side, and formed with respective convex parts on an inner surface of the central part reflecting the concave form on the outer surface, and
wherein, when the first locking part and the second locking part of the first bundling member are folded down, the end parts thereof respectively abut on the concave parts on the outside of the first embossed part and the second embossed part of the second bundling member, and when the first locking part and the second locking part of the second bundling member are folded down, the end parts thereof respectively abut on the concave parts on the outside of the first embossed part and the second embossed part of the first bundling member.

3. The bundling tool according to claim 2,
wherein the central parts of the first bundling member and the second bundling member accommodate the wires between the inner surfaces thereof at locations other than the convex parts on the inside of the first embossed part and the second embossed part.

4. The bundling tool according to claim 1,
wherein the first locking part and the second locking part of the first bundling member and the second bundling member each include the end part narrowing toward a tip end thereof.

5. The bundling tool according to claim 1,
wherein the first locking part and the second locking part of the first bundling member and the second bundling member have lengths within a range of between 180% and 220% of the diameter of one of the wires before being crimped.

6. (canceled)

7. The bundling tool according to claim 1,
wherein, when the first bundling member and the second bundling member crimp the plurality of wires, the first bundling member and the second bundling member are fixed in a distance approximately equal to the diameter of one of the wires before being crimped.

8. The bundling tool according to claim 1,
wherein the first locking part and the second locking part of the first bundling member are welded at respective abutment locations with the second locking part and first locking part of the second bundling member.

9. The bundling tool according to claim 1,
wherein the first locking part and the second locking part of the first bundling member and the second bundling member have widths narrower than the diameter of one of the wires before being crimped.
